(19) United States
(12) Patent Application Publication
(10) Pub. No.: US 2026/0205820 A1
(43) Pub. Date: Jul. 16, 2026

(54) METHOD FOR USER DEVICE AND ACCESS DEVICE INTERACTION

(71) Applicant: Visa International Service Association, San Francisco, CA (US)

(72) Inventors: Debdeep Bandyopadhyay, Durgapur (IN); Manav Shah, San Francisco, CA (US); Satyam Raj, Bengaluru (IN); Mansi Singh, San Francisco, CA (US)

(73) Assignee: Visa International Service Association, San Francisco, CA (US)

(21) Appl. No.: 19/021,011

(22) Filed: Jan. 14, 2025

(51) Int. Cl. H04W 12/37; H04W 12/68; G06N 20/20

(52) U.S. Cl. CPC H04W 12/37; H04W 12/68; G06N 20/20

(57) ABSTRACT

Described herein is a method performed by a user device that interacts with an access device. The user device determines input data at a plurality of sensors included in the user device in response to a movement of the user device by a user. Using a trained machine learning model, the user device classifies the input data as being a specific movement pattern of a plurality of specific movement patterns. The user device identifies an access data instance associated with the specific movement pattern. Further, the user device transmits, using a first RF antenna, the access data instance to an access device comprising a second RF antenna. The access device in turn generates an authorization request message comprising the access data instance.

### BACKGROUND

Mobile devices frequently interact with other devices e.g., access devices, in order to execute various operations. For instance, a mobile device may interact with an access device to execute an operation such as verification for access to a resource.

Currently, in interactions such as access transactions, payment transactions, and data access transactions, different types of access data may be used. If the user wishes to switch the type of access data that will be used with an access device, one may need to manually open an application and select a specific type of access data. The process of switching access data is cumbersome and time-consuming. Users are required to navigate through multiple steps within their application(s) to change the default access data, thereby interrupting the flow of the interaction. This lack of on-the-fly access data selection limits user convenience (e.g., has a negative effect on user engagement) and flexibility during transactions.

Embodiments of the disclosure address this problem and other problems individually and collectively.

### SUMMARY

One embodiment is related to a method performed by a user device comprising a processor, a memory storing a plurality of access data instances coupled to the processor, a plurality of sensors coupled to the processor, and a first RF antenna coupled to the processor, the method comprising: determining, by the processor, input data at the plurality of sensors in response to a movement of the user device by a user; classifying, using a trained machine learning model, the input data as being a specific movement pattern of a plurality of specific movement patterns; identifying, by the processor, an access data instance associated with the specific movement pattern; and transmitting, using the first RF antenna, the access data instance to an access device comprising a second RF antenna, wherein the access device generates an authorization request message comprising the access data instance.

Another embodiment of the invention is directed to a user device comprising: a processor; and a computer-readable medium coupled to the processor, the computer-readable medium including code executable by the processor for performing: determining, by the processor, input data at the plurality of sensors in response to a movement of the user device by a user; classifying, using a trained machine learning model, the input data as being a specific movement pattern of a plurality of specific movement patterns; identifying, by the processor, an access data instance associated with the specific movement pattern; and transmitting, using the first RF antenna, the access data instance to an access device comprising a second RF antenna, wherein the access device generates an authorization request message comprising the access data instance.

These and other embodiments are described in further detail below. Further details regarding embodiments of the disclosure can be found in the Detailed Description and the Figures.

### BRIEF DESCRIPTION OF THE DRAWINGS

FIG. 1 depicts an exemplary interaction between a user device and an access device, according to some embodiments.

FIG. 2 shows a block diagram of components of a user device according to some embodiments.

FIG. 3 depicts an exemplary mapping table stored in a memory of a user device according to some embodiments.

FIG. 4 depicts an exemplary flowchart illustrating steps performed by a user device, according to some embodiments.

FIG. 5 shows a block diagram of components of an access device according to some embodiments.

### DETAILED DESCRIPTION

Prior to discussing embodiments of the disclosure, some terms can be described in further detail.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. There are a variety of input sensors capable of detecting user input. Exemplary input sensors include accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user” may include an individual. In some embodiments, a user may be associated with one or more personal accounts and/or mobile devices. The user may also be referred to as a cardholder, account holder, or consumer in some embodiments.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Interaction data” can include data related to and/or recorded during an interaction. Interaction data can be provided from a user device to another device (e.g., an access device, etc.). Interaction data can be provided in one or more communications between a user device and an access device (e.g., in one or more application protocol data units (APDUs)). For example, interaction data can be provided from a user device in a select PPSe message(s), select AID message(s), get processing options (GPO) message(s), read record message(s), etc. In some embodiments, interaction data can include a primary account number (PAN), a token, a cryptogram, etc.

An “access data instance” can be an instance of access data such as credentials, tokens, digital signatures, and the like.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a sub token, a gift card number or code, a prepaid card number or code, a username, an expiration date, a CVV (card verification value), a dCVV (dynamic card verification value), a CVV2 (card verification value 2), a CVC3 card verification value, etc. An example of a PAN is a 16-digit number, such as “4147090000001234”. In some embodiments, credentials may be considered sensitive information.

A “token” may be a substitute value for a credential. A token may be a string of numbers, letters, or any other suitable characters. Examples of tokens include access tokens such as payment tokens, data that can be used to access secure systems or locations, etc.

A "payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900000000000001” may be used in place of a PAN “414709000000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Machine learning” can include an artificial intelligence process in which software applications may be trained to make accurate predictions through learning. The predictions can be generated by applying input data to a predictive model, which is formed by performing statistical analyses on aggregated data. A model can be trained using training data, such that the model may be used to make accurate predictions. The prediction can be, for example, a predicted classification of an image, a predicted purchase of a user, etc.

An “artificial intelligence application” or machine learning model may include an application of artificial intelligence that provides systems with the ability to automatically learn and improve from experience without explicitly being programmed. An artificial intelligence application or machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. An artificial intelligence application may have an artificial intelligence identifier or ID associated with it to identify it from among other artificial intelligence applications. It may further store or have access to a secret cryptographic key such as a private key of a public-private key pair. The public-private key pair may be assigned to a specific artificial intelligence module.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a numerical representation of relative happiness, etc. Feature vectors can be represented and stored electronically in a feature store. Further, a feature vector can be normalized, i.e., be made to have unit magnitude. As an example, the feature vector (12, 15, 22, 5) corresponding to “LOVE” could be normalized to approximately (0.40, 0.51, 0.74, 0.17).

An “access device” may include any suitable device for providing access to an external computer system. An access device may be in any suitable form. Some examples of access devices include point-of-sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a mobile device.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval -- transaction was approved; Decline -- transaction was not approved; or Call Center -- response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “resource provider” may be an entity that can provide a resource such as goods, services, information, and/or access. Examples of resource providers includes merchants, data providers, transit agencies, governmental entities, venue and dwelling operators, etc.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers. The server computer may also be configured to authenticate authorization request messages received from an access device.

An “issuer” may refer to a business entity (e.g., a bank) that issues and optionally maintains an account for a user. An issuer may also issue payment credentials stored on a user device, such as a cellular telephone, smart card, tablet, or laptop to the consumer.

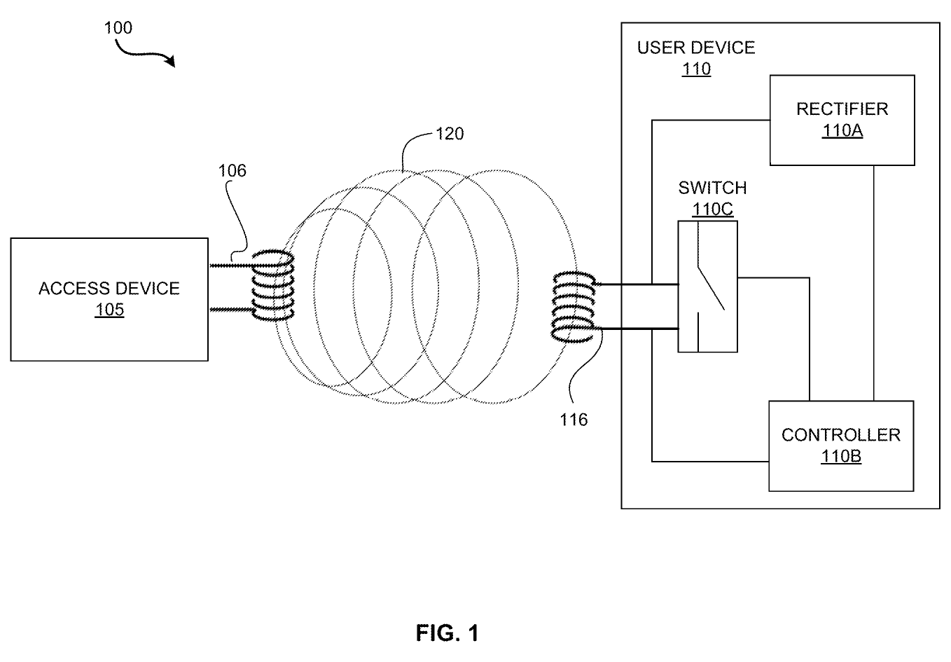

FIG. 1 depicts an exemplary system 100 and an interaction between an active device (e.g., access device 105) and a passive device (e.g., user device 110). In one example, the active device may correspond to a payment terminal (e.g. POS terminal), and the passive device may correspond to a user’s mobile phone. As shown in FIG. 1, the access device 105 is equipped with a RF antenna or RF coil 106 (i.e., a first RF antenna/coil), which is configured to induce an electromagnetic induction field (EMF) 120 on a RF antenna or RF coil 116 of the user device 110 (i.e., a second RF antenna/coil). The user device 110 further includes a rectifier 110A, a controller 110B, and a switch 110C. The interaction between the active device and the passive device may correspond to a contactless application such as a contactless payment application or a contactless access application. It is appreciated that in the context of a contactless interaction, the user device 110 can have a component that acts as a passive device (i.e., does not generate energy by itself), whereas the access device 110 is an active device (i.e., generates energy e.g., radio waves, and fetches information from the passive device via a coupling (e.g. EMF coupling 120) formed between the access device 105 and the user device 110). It is noted that the coupling between the access device 105 and the user device 110 is formed when the user device 110 is in close proximity (i.e., within a threshold distance) from the access device 105.

In contactless applications that use Near Field Communication (NFC) for conducting transactions (e.g., contactless payments), the rectifier 110A, the controller 110B, and the switch 110C (e.g., an ON/OFF switch) included in the user device 110 are components that manage how the user device interacts with the access device and ensures that the transaction occurs securely.

The access device 105 induces an EMF on the user device 110 thereby activating circuitry of the user device 110, which responds with required information to initiate the interaction process. The EMF induced on the RF antenna of the user device 110 (i.e., second RF antenna) is converted to a DC current by the rectifier 110A. The rectifier 110A may also be configured to perform a variety of other functions such as data standardization and conversion processes, execute a signal integrity function, and an error checking function.

For instance, with regard to data standardization, the rectifier 110A ensures that the transaction information transmitted between the user device 110 and the access device 105 is in a proper format. With regard to signal integrity, the rectifier 110A could also be responsible for ensuring that the signal (such as the NFC transmission) between the user device 110 and the access device 105 is clear, strong, and without interference. If any disruptions in the signal occur, the rectifier 110A ensures that the data is correctly encoded and decoded for a successful transmission. Additionally, with regard to error checking, the rectifier 110A helps verify data integrity, ensuring that the data being transmitted has not been tampered with, corrupted, or altered during transmission.

According to some embodiments, the controller 110B is the brain of the interaction operation between the user device 110 and the access device 105. The controller 110B is responsible for managing the entire flow of the interaction operation, i.e., from initiation to completion. The controller 110B ensures that data is properly exchanged, securely processed, and validated. The roles of the controller 110B may include (but not limited to): (i) Interaction/Transaction Management: The controller oversees the interaction between the user device 110 and the access device 105. It ensures that the NFC communication is initiated and that the appropriate data (e.g., tokenized payment information such as a virtual card number) is securely transmitted to the access device 105; (ii) Security and Authentication: The controller 110B handles security protocols, including encryption and authentication. It interacts with the user device’s secure element (SE) or trusted execution environment (TEE) to encrypt the information required for the interaction. It also manages user authentication mechanisms such as biometric authentication (fingerprint or face recognition) or PIN entry to ensure the user is authorized to make the interaction with the access device 105; and (iii) Session Management - The controller 110B ensures that the transaction session is properly established, maintained, and closed, ensuring a secure communication session throughout the interaction.

The switch 110C in the context of a contactless transaction plays a role in managing the activation and deactivation of the mobile device’s NFC capabilities and controlling the payment functionality. The switch 110C may be a physical switch or a software-based switch, depending on the user device's design. The roles of the switch 110C may include (but not limited to): NFC Activation – the switch controls whether the user device's NFC chip is active or inactive. NFC is required for a contactless transaction, so the switch 110C ensures that the NFC functionality is turned ON when a payment is to be made and OFF when it’s not in use i.e., when not needed, the switch 110C disables NFC to save power and prevent unwanted interactions with payment terminals. Further, the switch 110C may also perform power management functions- on many devices, the NFC feature consumes power even when it is not actively being used. The switch 110C helps manage battery usage by controlling when NFC is actively searching for access devices e.g., POS terminals. Additionally, the switch 110C may also perform security control functions i.e., the switch may also have a role in controlling access to sensitive information. For example, turning off the NFC feature when the user device is idle may help prevent unauthorized access to sensitive information from malicious devices.

According to some embodiments, the user device 110 utilizes a plurality of access data instances that are stored in a memory of the user device 110 to conduct different types of interactions with one or more access devices. As stated previously, access data instances can be entities such as credentials of a user, different types of tokens, different types of credit/debit cards or the like that can be used in a variety of applications. Each access data instance can be mapped or associated with a unique movement of the user device e.g., a gesture performed with the user device in a specific manner.

Thus, the user may perform specific movements of the user device 110 in order to utilize the access data instance (associated with the specific movement) for a particular application. For example, considering a contactless payment application, the user may perform a certain movement of the user device to trigger the usage of a specific card (e.g., credit card or debit card). The specific card is associated with the certain movement of the user device in conducting a transaction (e.g., payment transaction) using the specific card. Similarly, considering another example of where the user desires to gain access to a resource (e.g., provided by a resource computer), the user could utilize the above framework of performing a specific movement of the user device in order to utilize a specific credential (associated with the specific movement) to gain access to the resource.

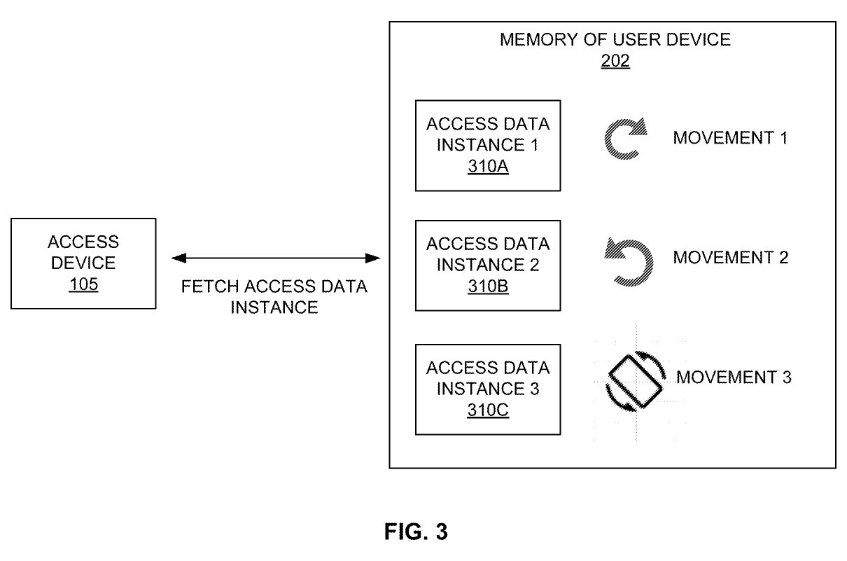

In some embodiments, the user device maintains (i.e., stores) a mapping table including a plurality of access data instances in a memory of the user device 110. Each access data instance in mapped to a unique movement pattern of the user device. Thus, upon the user performing a specific movement pattern of the user device, the access data instance associated with the specific movement pattern is retrieved/obtained from the mapping table and used in a specific interaction with the access device. FIG. 3 depicts an exemplary mapping table stored in a memory of a user device according to some embodiments. FIG. 3 illustrates three access data instances 310A, 310B and 310C that are each mapped to unique movements of the user device. Specifically, access data instance 1 (310A) is mapped to a clockwise rotation of the user device (i.e., movement 1), whereas access data instance 2 (310B) is mapped to a counter-clockwise rotation of the user device (i.e., movement 2), and access data instance 3 (310C) is mapped to a shaking movement of the user device (i.e., movement 3). Thus, in operation, when a user performs for instance, movement 1 of the user device (when the user device is positioned in close proximity of the access device), then access data instance 1 (310A) is used in that interaction.

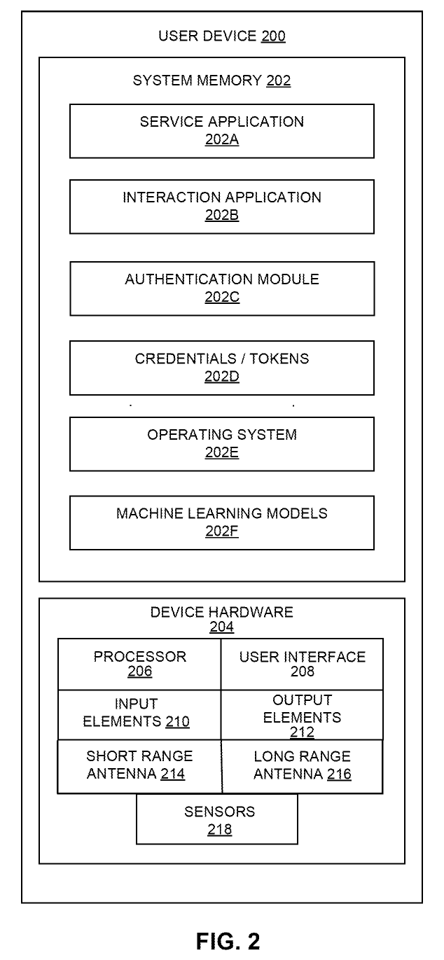

In order to determine the specific movement pattern of the user device performed by the user, the user device 110 utilizes one or more sensors (e.g., sensors 218 as shown in FIG. 2). The one or more sensors may include an accelerometer, a gyroscope, a magnetometer, a proximity sensor, a barometer, and an ultrasonic sensor. The one or more sensors may be configured to collect input data in response to a movement of the user device by a user. For example, the accelerometer may be configured to measure acceleration along three axes (x, y, z). Such acceleration measurement may be essential for detecting linear motion, shaking, tilting, and/or other specific movements (e.g., gestures) that involve changes in speed. The gyroscope may be configured to measure angular velocity around three axes. Measurement of angular velocity may be utilized for determining rotational movements like swiping, flipping, and rotating the phone.

The magnetometer may be configured to measure a magnetic field around the user device. While primarily used for determining direction (e.g., compass), the magnetometer can also contribute to user device movement recognition, especially when combined with other sensors. The proximity sensor included in the user device may be used for detecting objects near the phone, often used for screen activation/deactivation but can also provide additional context for user device movement recognition. The barometer sensor included in the user device may be primarily used for altitude measurement(s). However, it can indirectly contribute to user device movement recognition by detecting changes in atmospheric pressure related to movement. Additionally, the user device 110 may include an ultrasonic sensor that is used for features such as proximity sensing, gesture recognition, more precise distance measurements, etc.

In some implementations, user device 110 utilizes one or more machine learning models to predict/classify the input data as being a specific movement pattern of a plurality of specific movement patterns. The machine learning model may be a classification type machine learning model e.g., a logistic regression model (for binary classification tasks or linear decision boundaries), a decision tree model (for interpretable models and handling both categorical and continuous features), a random forest model (e.g., for an ensemble method for better accuracy than individual decision trees), a support vector machine model (for high dimensional spaces), a neural network model (for complex scenarios such as particularly when dealing with large datasets or deep learning tasks), etc.

Thus, in operation, upon a user performing a movement pattern of the user device, the one or more sensors included in the user device 110 capture input data related to the movement. Such input data undergoes a feature extraction and vectorization process. It is appreciated that feature extraction corresponds to the process of transforming raw data i.e., input data, into a feature vector. Feature extraction involves identifying and selecting the most relevant attributes (features) that describe the input data. In other words, a feature vector is constructed based on the input data, where each element of the feature vector corresponds to a specific attribute of that movement instance. The constructed feature vector in input to a machine learning model that is configured to classify the movement pattern of the user device as a specific movement pattern. Upon classifying the movement pattern, the user device is configured to select the access data instance associated with the movement pattern and use the selected access data instance in an interaction with the access device.

It is noted that the machine learning model may be previously trained and evaluated using a training dataset and/or a validation dataset. Training the machine learning model may involve the steps of feeding the model with the known feature vectors and their corresponding class labels. The training process may also involve adjusting the model’s internal parameters (e.g., weights in logistic regression, or splits in decision trees) to minimize the error or loss function. Furthermore, hyperparameter tuning may also be performed. Some classifiers have hyperparameters (e.g., learning rate, number of trees in a random forest, or kernel type in SVMs) that can be tuned for better performance. Techniques like grid search or random search can be used for hyperparameter optimization.

In some implementations, a model ensemble technique may be implemented in performing the classification. For instance, a plurality of machine learning models may be combined to generate an ensemble machine learning model. The ensemble machine learning model is further trained to generate a trained machine learning model. Additionally, in some embodiments, further additional mechanisms such as dynamic time warping (for handling variations in execution speed of the movement of the user device), continuous learning (e.g., to allow the model to adapt to new movements or changes in user behavior), and/or edge computing (i.e., making the model lightweight to be used as an embedded model in the user device) may be utilized to further refine/improvise the trained machine learning model.

Additionally, it is noted that embodiments of the present disclosure provide various advantages. For instance, the trained machine learning model is embedded in the user device 110 and thus can perform the above described functions (e.g., determining input data in response to a movement of the user device, classifying the input data as being a specific movement pattern, and transmitting the access data instance to an access device) in an offline mode of operation (e.g., without an active Internet connection). With regard to a contactless application, it is noted that the user device can transmit a particular access data instance to an access device without activating or opening any application (e.g., payment applications) installed on the user device. Further, by some embodiments, a user/classification error resolution technique is provided. Specifically, in this technique, a stack data object is utilized that is configured to store an access data instance corresponding to a movement of the user device performed by the user. In case, the user unknowingly performed an incorrect movement pattern of the user device, then a certain time threshold is provided within which the user may perform the correct movement pattern of the user device. As such, the access data instance previously stored in the stack is replaced with a new access data instance that corresponds to the correct movement pattern of the user device. A processor of the user device may be configured to obtain the new access data instance from the stack to utilize it in an interaction with the access device.

FIG. 2 illustrates a user device 200 according to an embodiment. It is noted that the user device 200 may correspond to a mobile communication device such as a smartphone. The terms mobile communication device and user device are thus used synonymously herein. Mobile communication device 200 may include device hardware 204 coupled to a system memory 202.

Device hardware 204 may include a processor 206, a short range antenna 214, a long range antenna 216, input elements 210, a user interface 208, output elements 212 (which may be part of the user interface 208), and one more sensors 218. Examples of input elements may include microphones, keypads, touchscreens, etc. Examples of output elements may include speakers, display screens, and tactile devices. The processor 206 can be implemented as one or more integrated circuits (e.g., one or more single core or multicore microprocessors and/or microcontrollers) and is used to control the operation of mobile communication device 200. The processor 206 can execute a variety of programs in response to program code or computer-readable code stored in the system memory 202 and can maintain multiple concurrently executing programs or processes.

The long range antenna 216 may include one or more RF transceivers and/or connectors that can be used by mobile communication device 200 to communicate with other devices and/or to connect with external networks. The user interface 208 can include any combination of input and output elements to allow a user to interact with and invoke the functionalities of mobile communication device 200. The short range antenna 214 may be configured to communicate with external entities through a short range communication medium (e.g., using Bluetooth, Wi-Fi, infrared, NFC, etc.). The long range antenna 216 may be configured to communicate with a remote base station and a remote cellular or data network, over the air.

The one or more sensors 218 may include an accelerometer, a gyroscope, a magnetometer, a proximity sensor, a barometer, and an ultrasonic sensor. The one or more sensors 218 may be configured to collect input data in response to a movement of the user device by a user. For example, the accelerometer may be configured to measure acceleration along three axes (x, y, z). Such acceleration measurement may be essential for detecting linear motion, shaking, tilting, and/or other specific movements (e.g., gestures) that involve changes in speed. The gyroscope may be configured to measure angular velocity around three axes. Measurement of angular velocity may be utilized for determining rotational movements like swiping, flipping, and rotating the phone. The magnetometer may be configured to measure a magnetic field around the user device. While primarily used for determining direction (e.g., compass), the magnetometer can also contribute to user device movement recognition, especially when combined with other sensors. The proximity sensor included in the user device may be used for detecting objects near the phone, often used for screen activation/deactivation but can also provide additional context for user device movement recognition. The barometer sensor included in the user device may be primarily used for altitude measurement(s). However, it can indirectly contribute to user device movement recognition by detecting changes in atmospheric pressure related to movement. Additionally, the user device 200 may include an ultrasonic sensor that is used for features such as proximity sensing, gesture recognition, more precise distance measurements, etc.

The system memory 202 can be implemented using any combination of any number of non-volatile memories (e.g., flash memory) and volatile memories (e.g., DRAM, SRAM), or any other non-transitory storage medium, or a combination thereof media. The system memory 202 may store computer code, executable by the processor 206, for performing any of the functions described herein. For example, the system memory may comprise a computer readable medium comprising, code for causing the processor 206 to perform a method comprising: determining input data at the plurality of sensors in response to a movement of the user device by a user; classifying, using a trained machine learning model, the input data as being a specific movement pattern of a plurality of specific movement patterns; identifying an access data instance associated with the specific movement pattern; and transmitting, using the first RF antenna, the access data instance to an access device comprising a second RF antenna, wherein the access device generates an authorization request message comprising the access data instance.

The system memory 202 may also store a service application 202A, an interaction application 202B, an authentication module 202C, credentials/tokens/device fingerprints 202D, and an operating system 202E, The service application 202A may include instructions or code initiating and conducting a transaction with an external device such as an access device or a processing computer. The interaction application 202B may include code, executable by the processor 206, for forming a local connection or otherwise interacting with an external access device and/or a portable device. The authentication module 202C may comprise code, executable by the processor 206, to authenticate a user. This can be performed using user secrets (e.g., passwords) or user biometrics.

System memory 202 may also store credentials and/or tokens 202D. Credentials may also include information identifying the mobile communication device 200 and/or the user of the mobile communication device 200. System memory 202 may also a plurality of machine learning models 202F. Each of the plurality of machine learning models 202F may be trained to classify input data acquired by the sensors 218 into one of a plurality of specific movements of the user device. In other words, in response to a user of user device performing a specific movement with respect to the user device, the plurality of machine learning models is trained to predict the specific movement (of the user device) performed by the user and associate an access data instance (e.g., a credential or a token) with the specific movement of the user device. The access data instance may be transmitted to an access device in order to obtain access to a particular resource e.g., conduct a transaction using a particular access data instance.

Examples of the one or more machine learning models include, but are not limited to, an association-rule model (such as an Apriori algorithm, an Eclat algorithm, or an FP-growth algorithm), a clustering model (such as a hierarchical clustering module, a k-means algorithm, or other statistical clustering algorithms), a collaborative filtering model (such as a memory- or model-based algorithm), or an artificial intelligence model (such as an artificial neural network). Further, and as described herein, one or more of these machine learning models may be trained against, and adaptively improved using, training and testing datasets. Optionally, one may also create a validation dataset from the training data in order to validate the trained machine learning model and/or to tune one or more hyperparameters of the machine learning model. The hyperparameters of the machine learning model may be optimized using techniques such as grid search or random search.

In one implementation, the machine learning model is utilized by the user device to predict/classify, the input data as being a specific movement pattern of a plurality of specific movement patterns. The machine learning model may be a classification type machine learning model e.g., a logistic regression model (for binary classification tasks or linear decision boundaries), a decision tree model (for interpretable models and handling both categorical and continuous features), a random forest model (e.g., for an ensemble method for better accuracy than individual decision trees), a support vector machine model (for high dimensional spaces), a neural network model (for complex scenarios such as particularly when dealing with large datasets or deep learning tasks), etc. In some implementations, a model ensemble technique may be implemented in performing the classification. For instance, a plurality of machine learning models may be combined to generate an ensemble machine learning model. The ensemble machine learning model is further trained to generate a trained machine learning model. Additionally, in some embodiments, further additional mechanisms such as dynamic time warping (for handling variations in execution speed of the movement of the user device), continuous learning (e.g., to allow the model to adapt to new movements or changes in user behavior), and/or edge computing (i.e., making the model lightweight to be used as an embedded model in the user device) may be utilized to further refine/improvise the trained machine learning model.

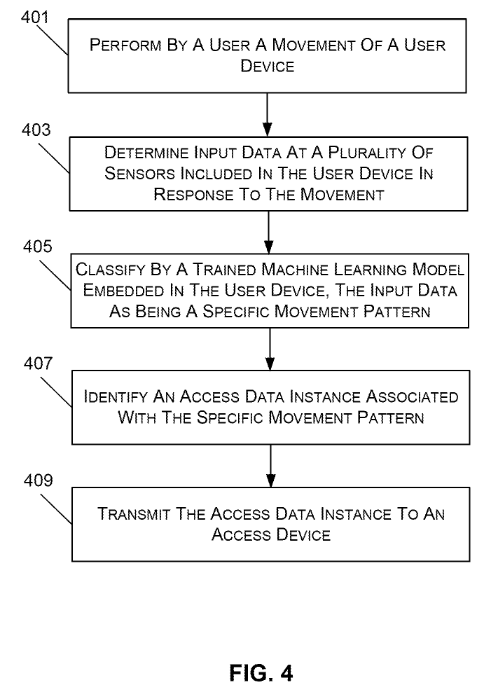

FIG. 4 depicts an exemplary flowchart illustrating steps performed by a user device, according to some embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order, or some steps may also be performed in parallel.

The process commences in step 401, where a user performs a movement of a user device. A movement of the user device corresponds to a gesture performed by the user with respect to the user device. It is noted that the user may perform such a movement when the user device is in close proximity of an access device with which the user device desires to communicate. For example, the movement performed with the user device may correspond to one of the movements depicted in FIG. 3.

The process then moves to step 403, where in response to the movement of the user device performed by the user, a plurality of sensors included in the user device determine input data corresponding to the movement. Such input data may include information indicative of a direction in which the user device is moved, an acceleration of the movement, etc. Upon determining the input data, in step 405, a trained machine learning model that is embedded in the user device classifies the input data as being a specific movement pattern. It is appreciated that the classification of the input data may include steps of feature extraction and vectorization. Specifically, feature extraction corresponds to the process of transforming raw data i.e., input data, into a feature vector. Feature extraction involves identifying and selecting the most relevant attributes (features) that describe the input data. The feature vector is constructed based on the input data, where each element of the feature vector corresponds to a specific attribute of that movement instance.

Thereafter, the process moves to step 407 where an access data instance associated with the specific movement pattern is identified. It is noted that such an identification can be performed via a lookup operation in a mapping table that stores information of a plurality of access data instance, where each access data instance is mapped to a unique movement pattern of the user device. The process then moves to step 409, where the user device transmits (e.g., by using an RF antenna) the obtained access data instance to an access device. The access device upon receiving the access data instance may generate authorization request message comprising the access data instance. By some embodiments, the authorization request message generated by the access device is transmitted to a server computer that may be configured to authenticate the access data instance. In this manner, upon successful authentication of the access data instance, an interaction between the user device and the access device can be completed.

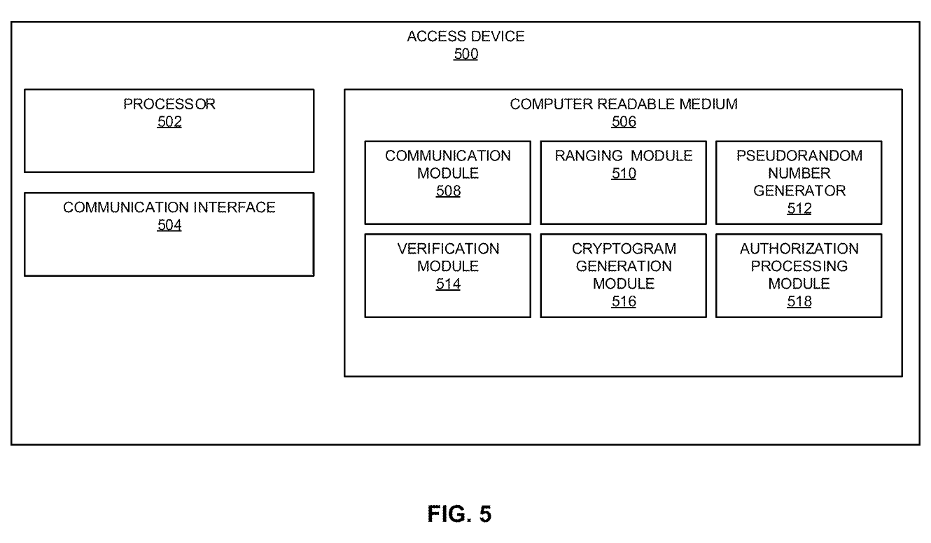

Turning to FIG. 5, there is depicted a system block diagram of an exemplary access device e.g., a POS terminal 500 comprising a processor 502, a communication interface 504 and a computer readable medium 506, comprising or storing a number of software modules, including a communication module 508, a ranging module 510, a pseudorandom number generator 512, a verification module 514, a cryptogram generation module 516, and an authorization processing module 518.

Processor 502 may comprise any suitable data computation device or devices. Processor 502 may be able to interpret code and carry out instructions stored on computer readable medium 506. Processor 502 may comprise a Central Processing Unit (CPU) operating on a reduced instructional set, and may comprise a single or multi-core processor, or any other appropriate processing unit. Processor 502 may also include an Arithmetic Logic Unit (ALU) and a cache memory.

Communication interface 504 may comprise any interface by which the access device 500 can communicate with other computers or devices e.g., the passive device 110 of FIG. 1 (i.e., the user device). Examples of communication interfaces include wired interfaces, such as USB, Ethernet, or FireWire, as well as wireless interfaces such as Bluetooth^{®}, Wi-Fi, NFC transceivers or ultra-wide band (UWB) transceivers. Access device 500 can possess multiple communication interfaces 504. As an example, access device may communicate with a passive device via a Bluetooth^{®} transceiver, an NFC transceiver, or a UWB transceiver and a processing network computer via an Ethernet interface.

Communication module 508 may comprise code, software or instructions that may be interpreted and executed by processor 502. This software may be used by access device 500 in order to communicate with other devices, such as the passive device 110 of FIG. 1. The communication module 508 may include code or instructions for receiving and interpreting messages or other transmissions from passive devices. Communication module 508 may enable access device 500 to communicate with other computers and devices (e.g., a server computer, issuer computer, etc.) according to any appropriate communication protocol.

Ranging module 510 may comprise code or instructions, executable by the processor 502 for performing functions associated with determining distance measurements. For example, the ranging module 510 may comprise code enabling the access device 500 to perform a double-sided two-way ranging procedure with a passive device e.g., passive device 110 of FIG. 1. Pseudorandom number generator 512 may comprise code or instructions, executable by processor 502 for generating random and pseudorandom numbers using any appropriate method or algorithm. These random or pseudorandom numbers can include for instance, session numbers that can be generated for each instance of a distance measurement between the access device and the passive device.

Verification module 514 may comprise code or instructions, executable by processor 502 for verifying cryptograms or other data received from passive devices. Verification module 514 can also be used to compare a distance measurement to a predetermined distance threshold, in order to verify that a passive device is present during a data transfer. According to some embodiments, the verification module 514 may be programmed to compare a distance measurement performed by the passive device (e.g., a first distance measurement between the passive device and the access device) to a distance measurement performed by the access device 500 (e.g., a second distance measurement between the passive device and the access device). Based on the comparison, the access device may determine a risk of a relay attack. For instance, if a difference between the first and second distance measurements exceeds a threshold, then the access device 500 may successfully identify a presence of a relay attack.

Cryptogram generation module 516 may comprise code or instructions, executable by the processor 502 for generating cryptograms using any appropriate method. For example, the access device 500 can generate cryptograms by encrypting random identifiers, distance measurements, and the like using a symmetric or asymmetric cryptographic key.

Authorization processing module 518 may comprise code or instructions, executable by processor 502 for authorizing some interaction based on a data transfer between the passive device and the access device. For example, if the access device 500 comprises a system used to control access to a secure building, the authorization processing module 518 may comprise code used to, for example, verify a credential used to access the secure building and/or to transmit signals unlocking a door to the secure building based on results of distance computations performed by the verification module 514. In another instance, e.g., in a transaction based system, the authorization processing module 518 may comprise code or instructions, executable by processor 502 for generating and transmitting authorization request messages and receiving and interpreting authorization response messages.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of "a," "an," or "the" is intended to mean "at least one," unless specifically indicated to the contrary.

What is claimed is:

1. A method performed by a user device comprising a processor, a memory storing a plurality of access data instances coupled to the processor, a plurality of sensors coupled to the processor, and a first RF antenna coupled to the processor, the method comprising:
determining, by the processor, input data at the plurality of sensors in response to a movement of the user device by a user;
classifying, using a trained machine learning model, the input data as being a specific movement pattern of a plurality of specific movement patterns;
identifying, by the processor, an access data instance associated with the specific movement pattern; and
transmitting, using the first RF antenna, the access data instance to an access device comprising a second RF antenna, wherein the access device generates an authorization request message comprising the access data instance.

2. The method of claim 1, wherein the access data instances are different credentials or different tokens.

3. The method of claim 1, further comprising:
training a machine learning model to form the trained machine learning model.

4. The method of claim 1, wherein the user device is a mobile phone.

5. The method of claim 1, wherein the trained machine learning model is accessible to the user device, and wherein the user device is configured to perform at least the steps of determining, classifying, and identifying in an offline mode of operation.

6. The method of claim 1, further comprising:
storing, in a mapping table, the plurality of access data instances, each access data instance of the plurality of access data instances being mapped to a unique movement pattern of the user device; and
responsive to the input data being classified as the specific movement pattern, selecting from the mapping table, the access data instance corresponding to the specific movement pattern.

7. The method of claim 1, wherein the trained machine learning model is accessible to the user device, and wherein the user device is configured to perform at least the steps of determining, classifying, and identifying without activating or opening any application installed on the user device.

8. The method of claim 1, wherein the access device is a POS terminal.

9. The method of claim 1, wherein the access device transmits the authorization request message comprising the access data instance to a server computer, the server computer configured to authenticate the access data instance.

10. The method of claim 1, further comprising:
combining a plurality of machine learning models to generate an ensemble machine learning model; and
training the ensemble machine learning model to generate the trained machine learning model.

11. The method of claim 1, wherein the plurality of sensors comprise:
an accelerometer,
a gyroscope,
a magnetometer,
a proximity sensor,
a barometer, or
an ultrasonic sensor.

12. A user device comprising:
a processor; and
a non-transitory computer readable medium coupled to the processor and comprising code, executable by the processor, for implementing a method comprising:
determining input data at a plurality of sensors in response to a movement of the user device by a user;
classifying, using a trained machine learning model, the input data as being a specific movement pattern of a plurality of specific movement patterns;
identifying an access data instance associated with the specific movement pattern; and
transmitting, using a first RF antenna, the access data instance to an access device comprising a second RF antenna, wherein the access device generates an authorization request message comprising the access data instance.

13. The user device of claim 12, wherein the access data instances are different credentials or different tokens.

14. The user device of claim 12, wherein the processor is further configured for:
training a machine learning model to form the trained machine learning model.

15. The user device of claim 12, wherein the user device is a mobile phone.

16. The user device of claim 12, wherein the trained machine learning model is accessible to the user device, and wherein the user device is configured to perform at least the steps of determining, classifying, and identifying in an offline mode of operation.

17. The user device of claim 12, wherein the processor is further configured for:
storing, in a mapping table, a plurality of access data instances, each access data instance of the plurality of access data instances being mapped to a unique movement pattern of the user device; and
responsive to the input data being classified as the specific movement pattern, selecting from the mapping table, the access data instance corresponding to the specific movement pattern.

18. The user device of claim 12, wherein the trained machine learning model is accessible to the user device, and wherein the user device is configured to perform at least the steps of determining, classifying, and identifying without activating or opening any application installed on the user device.

19. The user device of claim 12, wherein the access device is a POS terminal.

20. The user device of claim 12, wherein the processor is further configured for:
combining a plurality of machine learning models to generate an ensemble machine learning model; and
training the ensemble machine learning model to generate the trained machine learning model.
